(19) United States
(12) Patent Application Publication
(10) Pub. No.: US 2004/0088179 A1
(43) Pub. Date: May 6, 2004

(54) Emissions reduction portfolio

(76) Inventors: Jack D. Cogen, New York, NY (US); Fiona Kathryn Gadd, Cheshire (GB)

Correspondence Address: EDMOND R. BANNON, Fish & Richardson P.C., 45 Rockefeller Plaza, Suite 2800, New York, NY, 10111, US

(21) Appl. No.: 10/288,916

(22) Filed: Nov. 6, 2002

(51) Int. Cl. G06F 17/60

(52) U.S. Cl. 705/1; 705/412

(57) ABSTRACT

A computer-based method that includes receiving verified emission reductions (VERs) associated with emission reduction projects (ERPs) and converting the VERs into mutual portfolio units (MPUs) based on predetermined factors. An emissions reduction portfolio database of MPUs is created.

### TECHNICAL FIELD

The invention generally relates to a technique for generating an emissions reduction portfolio.

### BACKGROUND

Rising concentrations of greenhouse gases (GHGs) in the earth's atmosphere may result in irreversible climate changes. The GHGs include water vapor, methane, ozone, carbon monoxide, nitrous oxide, and carbon dioxide (CO₂). Carbon (in the form of CO₂ and methane) is emitted by volcanoes and by rotting vegetation and other organic matter, but is sequestered or absorbed by Carbon sinks such as trees (their roots, branches, trunks and leaves are composed mainly of carbon), plankton, soils and water bodies.

However, increases in burning of fossil fuels like coal, oil, and natural gas, in which carbon has been stored for millions of years, combined with accelerated land clearance has led to unprecedented levels of GHGs. Carbon sinks have not been able to keep up.

Because of concern over the increase in GHGs, many developed countries agreed to the United Nations Framework Convention on Climate Change (UNFCCC), which imposed limits on GHG emissions. Under the Kyoto protocol, developed countries are required to limit their GHG emissions to specified levels. The Kyoto protocol allows the use of Carbon sinks such as reforestation activities. The Kyoto protocol provides three mechanisms that may allow a country to reduce the cost of meeting their emissions caps by engaging in emissions reduction trading.

First, International Emissions Trading (IET) allows countries with excess emissions reductions to use or trade them to offset emissions at another source inside or outside the country. Second, Joint Implementations (JI) allows Annex 1 countries (developed countries or companies from these countries) to implement emission reduction projects jointly that limit or reduce emissions, or enhance sinks, and to share the emission reductions. Lastly, the Clean Development Mechanism (CDM) grants emissions credits for investments in emission reduction projects located in developing countries.

### SUMMARY

In one implementation, a first aspect of the invention includes a computer-based technique for receiving verified emission reductions (VERs) associated with emission reduction projects (ERPs) and converting the VERs into mutual portfolio units (MPUs) based on predetermined factors. An emissions reduction portfolio database of MPUs is created.

The aforesaid technique may include ERPs that include at least one of: a renewable energy project, emission reductions from process improvements in manufacturing, an energy efficiency improvement project, a fuel switching project, a carbon sequestration program, a transportation efficiency improvement project, a solar power technology project; a fuel-switching program; a reforestation project; or a project to reduce methane, perfluorocarbons (PFCs), hydrochlorofluorocarbons (HFCs), nitrous oxide (N2O) or sulphur hexafluoride (SF6) emissions. The predetermined factors may include at least one of a country in which an ERP is based, a country in which the seller of an ERP is based, the credit rating of a company associated with an ERP, the technology related to an ERP, catastrophic risk associated with an ERP, emission data associated with an ERP, and a government having jurisdiction over an ERP. The predetermined factors may include at least one of: a procurement risk, market risk, credit risk, fraud risk, or legal risk. The MPUs may have a risk profile of substantially the entire portfolio and are not tied to any specific ERP.

The techniques may include processing at least one of: a request to transfer ownership of MPUs between parties; processing a request to redeem MPUs from the portfolio; or processing a request to display over a network information associated with at least one of: VERs, ERPs, or MPUs. The techniques may include providing an investment review panel to review the predetermined factors and modifying the predetermined factors if any of a list of predetermined criteria change. The techniques may include converting the MPUs into valid compliance units (VCUs), and providing an insurance product to guarantee the conversion of MPUs into valid compliance units (VCUs).

The techniques may also include at least one of: charging membership fees for evaluating potential VERs for the portfolio; charging a percentage of the value of the VERs as a fee for converting VERs to MPUs; charging brokering fees for transferring MPUs between parties; or charging nominal administrative fees for redeeming MPUs.

In a second aspect, the invention provides an apparatus configured to perform the methods disclosed in the first aspect.

In a third aspect, the invention provides an article comprising a computer-readable medium that stores computer executable instructions for causing a computer to perform the methods disclosed in the first aspect.

In a fourth aspect, the invention provides a method based on the methods disclosed in the first aspect. In addition, this aspect includes processing at least one of a request to transfer ownership of at least one MPU between parties, and a request to redeem at least one MPU from the portfolio.

In a fifth aspect, the invention provides a method that includes providing consulting services to potential sellers of emissions reduction units (VERs), providing an account for holding VERs that have been validated and verified, and charging fees to process VERs.

In a sixth aspect, the invention provides a method that includes accepting verified emission reductions (VERs), converting accepted VERs into mutual portfolio units (MPUs), and issuing shares to sellers in exchange for the VERs

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of an emissions reduction portfolio system according to an implementation of the invention.

FIG. 2 is a flow chart of an emissions reduction portfolio system according to an implementation of the invention.

Like reference symbols in the various drawings indicate like elements.

### DETAILED DESCRIPTION

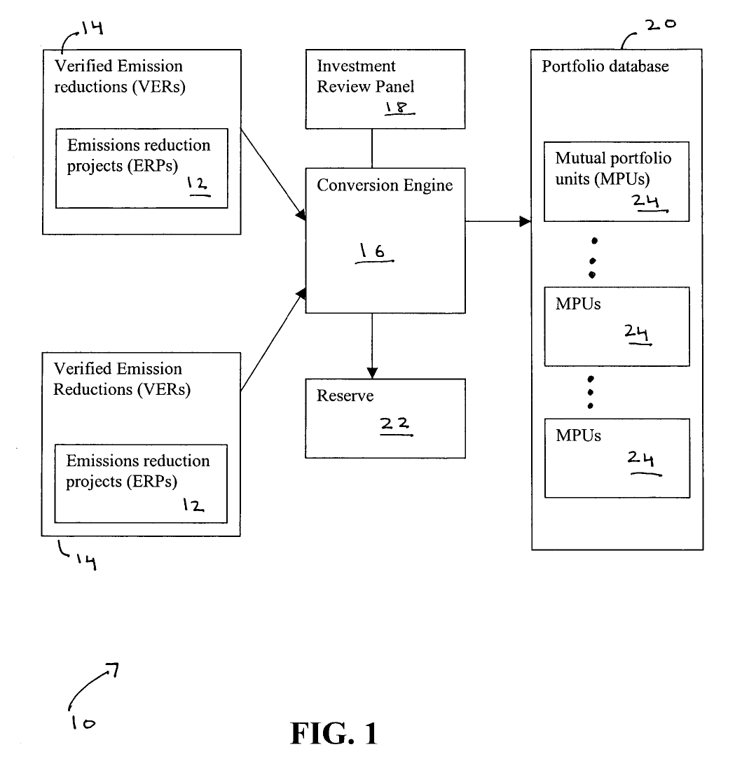

FIG. 1 is a block diagram of an emissions reduction portfolio system 10 according to an implementation of the invention. The system 10 includes a conversion engine 16 having a conversion process for converting verified emissions reductions (VERs) 14 associated with emissions reduction projects (ERPs) 12 to mutual portfolio units (MPUs) 24. The conversion engine 16 performs this conversion based on predetermined factors associated with ERPs 14 (e.g. the technology involved in ERPs). Information related to MPUs 24 is stored in a portfolio database 20 for subsequent processing including transfer and redemption transactions. VERs required to underwrite the risks within the conversion process are stored in a reserve 22. An investment review panel 18 may evaluate the performance of the conversion engine 16. Although MPUs 24 are based on ERPs 12, MPUs have a risk profile of substantially the entire portfolio 20 and are not tied to any specific ERP.

In general, a party, such as a shareholder having an account in the portfolio 20, may submit VERs 14 (i.e. units representing tonnes of emission reductions for meeting GHG emissions limits) associated with ERPs which may be subsequently converted to MPUs 24. The party may redeem one or more MPUs 24 at any time, such as for compliance or retirement purposes. Upon redemption, the shares associated with MPUs 24 are issued to the shareholder and the shares are canceled from the portfolio 20. The shareholder receives the amount of shares requested from its account. These shares are backed by a weighted combination of the portfolio's 20 overall mix of tonnes, up to the amount on deposit in the account. Similarly, the system 10 can facilitate transactions among account holders of the portfolio 20, as well as between account holders and non-account holders. The system 10 also facilitates transactions initiated by third-party brokers or directly between account holders and/or non-account holders.

A standard computer system (e.g. client/server configuration) can be used to implement the functions of the system 10. Such a system may include a computer having a processor and memory capable of executing one or more programs to perform the functions of the conversion engine 16 and a database for managing MPUs 24 of the portfolio 20. The computer system can include a network interface having hardware and software components to allow participants access to the system 10 over a network such as the World Wide Web using, for example, Web pages. The network interface may allow the system 10 to receive information related to ERPs, display information related to ERPS, MPUs or other information, and to process requests to transfer and redeem MPUs.

The system 10 performs functions similar to those performed by a bank, a rating agency, and a unit trust. As a bank, for example, sellers of VERs 14 may deposit their VERs into the system 10. However, the system 10 does not buy VERs 14, rather, the system provides an account where VERs may be held. The system 10 may provide assistance and expertise to the seller by permitting access to professional services associated with ERPs 12. It is anticipated that there will be preferential rates agreed with service providers which are accessible to participants.

Once VERs 14 are deposited and accepted into the system 10, the VERs may be assessed, rated and converted into MPUs. A resultant tonnage of MPUs can be returned as consideration or sold to an independent third party. This banking role is also similar to a custodian role. For example, the system 10 holds assets (i.e. MPUs), manages transfers between account holders and provides assurance and expertise in the ongoing management of assets for participants in the emission reductions market.

These activities have also been termed a Carbon Repository where the VERs are placed in the Repository for safe keeping and to ensure the development of a diversified Portfolio of emission reductions.

Although the system 10 can be viewed as a bank, it also differs from a bank in a number of ways. For example, in a bank, a cash deposit is typically made and subsequently the initial cash is extracted from the bank. In contrast, in the system 10, a deposit of VERs 14 (i.e. a particular amount of VER tonnes) is made and subsequently a new instrument (i.e. MPUs) is issued based on those (and other tonnes.) The MPUs 24 represent shares in the entire portfolio 20 of VERs and is an asset backed tradable security. Title to the depositors' own VERs 14 is signed over to the system 10 in exchange for MPUs 24.

As a rating agency, the system 10 may allow VERs 14 deposited in the portfolio to undergo a quality assessment. For example, the conversion engine 16 using a conversion process that evaluates a wide range of variables performs this process. The variables may provide a measure (e.g. conversion ratio) of the probability that VERs 14 will be delivered and of the quality of those VERs.

As a unit trust, the system 10 allows VERs 14 to be deposited into accounts and then converted to MPUs 24. The conversion process removes the identity of the seller. The MPUs 24 may be considered homogenous transferable instruments. They represent the portfolio 20 as a whole and are not linked to any specific underlying ERP 12. Thus, MPUs 24 hold the risk characteristics of the portfolio 20 as a whole.

The system 10 may charge the seller of VERs 14 a membership fee to cover registration, legal agreements and other set up costs involved in enrolling the seller into the system. The system 10 also may charge a fee for sourcing professional services. Once VERs 14 are deposited into the system 10, a commission may be charged (e.g. in the form of VERs) for handling transactions such as selling and redemption transactions. For example, when a seller of ERPs 12 submits 100 tonnes to the system 10, its account is credited with 95 tonnes and 5 tonnes are taken into the portfolio's own account for the commission on the deposit. Once the rating has been performed—the residual percentage of tonnes is taken to the reserve to help ensure that the MPUs may be guaranteed for compliance.

ERPs 12 refer to one or more projects for mitigating carbon emissions measured in tonnes of VERs 14. For example, a party (company/country) interested in selling VERs may be capable of delivering 50,000 tonnes of VERs per quarter. This party may have ERPs 12 that include rights to a landfill and plans on extracting methane from the site by flaring the gas. In another example, a party may be capable of delivering 100 tonnes of VERs 12 per year for ten years. This party may be a small operation engaged in ERPs 12 that include fuel switching programs involving switching from the consumption of paraffin to the use of solar energy.

The conversion engine 16 applies assessment criteria that include risks and factors associated with ERPs 12 when it converts ERPs to MPUs 24. For example, such factors may include the type of ERPs such as renewable energy projects, emission reductions from process improvements in manufacturing, energy efficiency improvement projects, fuel switching projects, carbon sequestration programs, transportation efficiency improvement projects, solar power technology projects, fuel-switching programs, reforestation projects, or projects to reduce methane, perfluorocarbons (PFCs), hydrochlorofluorocarbons (HFCs), nitrous oxide (N2O) or sulphur hexafluoride (SF6) emissions. Other factors may relate to ERPs 12 including the country in which ERPs are based, the country in which the seller of ERPs is based, the credit rating of a company associated with ERPs, the technology used for ERPs, catastrophic risk associated with ERPs, emission data associated with ERPs, the government having jurisdiction over ERPs, or other factors. The conversion engine 16 may also consider risks associated with ERPs 12 such as procurement risk, market risk, credit risk, fraud risk, and legal risk. The conversion engine 16 may incorporate one or more techniques to manage these risks and factors. Examples of such techniques include a risk weighting system in which relative scores are assigned to each of the factors, a decision tree technique in which the factors/risks represent nodes on the tree, or other techniques. These risks and factors are described in detail below.

A party interested in selling VERs 14 may provide information regarding the nature of the emission reductions that they are seeking to deposit in the system 10. Such information may include recent financial results, forecast financial performance indicators, future strategy documentation, technical specification of the project, baseline calculations (i.e. the amount of emissions before the project was initiated, where applicable) forecast emission reductions.

The conversion engine 16 may use this information as part of its assessment criteria to disaggregate and subsequently quantify the following risks associated with EPUs: procurement risk, market risk, credit risk, fraud risk, and legal risk. In general, procurement risk is an important risk to quantify prior to acceptance of VERs 14 into the system 10. Market and credit risk are of ongoing concern throughout the life of MPUs 24, and legal and fraud risks are common to most instruments transacted in the financial markets and also need monitoring on an ongoing basis. These risks may need to be quantified to enable the system 10 to effectively assess each VER 14 offered for submission to the portfolio 20. These risks are described in further detail below.

Procurement risk is the exposure of the portfolio's 20 financial performance arising from variation in the quality of ERPs 12 that are being accepted into the portfolio. It is associated with the qualification of ERPs 12 to the portfolio 20 as well as the potential for non-delivery of ERPs. This risk also includes the possibility of partial or total loss of value of ERPs 12 submitted to the portfolio 20 as collateral (i.e. an VER or MPU) which may expose the portfolio to financial loss.

Procurement risk may arise each time the portfolio considers accepting a third party's ERPs 12. The procurement risk includes the process by which both the quality and probability of delivery of the emission reduction is assessed. It also includes determining the ability of the portfolio 20 to subsequently honor its guarantees based on the MPUs issued to purchasers.

The sources of procurement risk may include: the eligibility of ERPs 12 relative to qualification criteria (i.e. risks and factors); the quality of monitoring of the emissions from ERPs; the quality of the determination of a baseline of ERPs against which to assess emissions reductions; the quality of the determination of ERPs boundaries; and the uncertainty over the ownership rights of the ERPs. The drivers (i.e. factors) of this risk may include: (for overseas projects) sovereign governments making political decisions not to authorize ERPs 12 or transfers of allowances or credits; the quality of an ERP design so that the project is not approved as delivering genuine reductions; use of inappropriate monitoring and reporting protocols for the measurement of emission reductions (i.e. the emission reductions are not verified and thus deemed not delivered).

The system 10 (i.e. conversion engine 16) may also quantify the following risks and factors associated with procurement risk: eligibility within the jurisdiction where the ERPs are undertaken; political change in the jurisdiction effecting ERP completion; environmental or developmental effects; measuring or monitoring procedures; baseline calculation methodology; technology change providing reductions for the ERP; verification standards for the ERP; accounting for the emission reductions of the ERP; natural disasters affecting operation or completion of the ERP; seller subsequently discovers they do not have ownership of the credit; and allocation issues—where current trading is based on anticipated future allowances which are not granted.

Market risk refers to the exposure of the portfolio's financial performance arising from the movements in the underlying prices of the commodities with which it is dealing. For the system 10 to remain solvent and to ensure it can meet all financial and contractual obligations when they fall due, market risk may be managed. The system 10 may be exposed to the risk that the market may fail for it requires market risk to exist for the value proposition to be realized.

Credit risk is the risk and uncertainty associated with the ability of counter-parties associated with VERs 14 to honor their contractual obligations in accordance with agreed terms. Specifically, the system 10 may manage this risk by ensuring that the assessment criteria for all third parties to the portfolio have been screened for suitability. The system 10 may continue to assess the counter-parties to provide early warnings of any potential default by a major counter-party potentially jeopardizing the system.

Fraud risk is the risk that parties may undertake illegal or unauthorized acts relating to the distribution of MPUs in the market. This risk is a standard risk for all financial instruments and standard risk identification, quantification and management techniques can be adapted for use in the system 10.

Legal risk refers to the possibility that property rights associated with VERs 14 may become enforceable. The legal risk within the system 10 can be managed by use of legal advice.

MPUs 24 are defined as a right to a specified future tonnage of emission reductions; however, the emission reductions used to provide that right are not specified. Rather, MPUs 24 are deemed to hold the combined characteristics of the basket of VERs 12 that are within the system 10. MPUs 24 may incorporate a guarantee that they can be converted into valid compliance units (VCUs) for whichever jurisdiction it is issued for use in a governmental GHG trading scheme. The system 10 may be capable of producing VCUs when the full rules for government schemes are established. One alternative, for example, may include providing an insurance product to guarantee convertibility of MPUs 24 to VCUs in specified jurisdictions.

MPUs 24 are similar to financial instruments which can be exercised within a specified time window (similar to an American option). For example, MPUs 24 may granted or purchased for exercise within a certain time date (i.e. for offset against emissions generated between Jan. 1, 2009 and Dec. 31, 2009) or by a certain date (i.e. for offset against any emissions generated between date of purchase and Jun. 30, 2008). Other financial structures and derivative products may be developed using MPUs 24 as a base. At the date of maturity of an MPU 24, the holder may present the contract to the system 10 where it is exchanged for the evidence and ownership of the emission reductions equaling the tonnage owed—whether in valid compliance units or another combination of tonnes and cash consideration.

Managers of the system 10 may maximize the value of the portfolio as they see fit. Operating guidelines and appropriate risk management criteria can be developed detailing what is and is not appropriate. The managers may be authorized (within limits) to: pass the existing VERs through a Clean Development Mechanism (CDM) to obtain compliant credits; to trade the existing VERs in the portfolio for other third party VERs where it perceives pricing mismatches; to liquidate VERs for cash to lock in significant gains; to transact in other stipulated instruments with similar risk characteristics to further diversify the portfolio's risk (for example through option structures developed in the emission trading market); and to purchase insurance providing guarantees to convert existing instruments to compliance units in the relevant jurisdiction.

In the current emission reduction trading market, sellers of VERs may need to ensure that their projects will qualify using criteria stated by purchasers. The definition of what qualifies may often vary depending on the requirements of the purchaser. The emission reduction will then need to be verified in the period in which it occurs, where the buyer will dictate the acceptable verification methodology. Currently a number of verification and validation criteria exist in the market and others can be defined by the purchaser. The system 10 is designed to avoid these complications in the emissions trading market and facilitate the trading of the market.

The system 10 may include predetermined and pre-published requirements for the validation of ERPs 12 and guidelines for the levels of verification required. This may permit potential sellers to structure their projects to maximize their chances of meeting the qualification criteria. The system 10 may include validation and verification procedures for ERPs 12.

The system 10 may help diversify risk for the purchaser of emission reductions (i.e. MPUs 24). For example, when a purchaser obtains MPUs 24 from the system 10, it is obtaining the future right to exchange the MPUs for verified emission reductions of a specific vintage. Since MPUs are part of the system 10, the relative emission received will be based on a proportion of the entire portfolio of emission reductions. The system 10 seeks to provide the tonnage agreed—although that may be tempered by the overall delivery of tonnes into the system 10.

The value of MPUs 24 may depend on the performance of the system 10. For example, if an MPU 24 is for the delivery of 100 tonnes of reductions, but the system 10 as a whole delivers 5% more reductions than expected (through a lower than anticipated default rate on VERs), then those excess reductions may be delivered to the MPU holder. Similarly, if the portfolio only delivers 95% of the intended reductions then the MPU holder will only receive 95% of the reductions they expected.

MPUs 24 obtained from the system 10 may reduce the risk of non-delivery risk. MPUs represent shares in the delivery risk from the portfolio of entities and projects participating in the portfolio, rather than the delivery risk from just one project. Individual sellers deposit their VERs in the portfolio—these create the portfolio effect that spreads the risk of non-delivery of emission reductions amongst the population of entities and projects in which it has invested. The risk of non-delivery has been assessed during conversion of ERPs into MPUs and has been factored into the conversion ratio of the ERPs to MPUs.

The system 10 may allow non-emitters to develop a long position. Participation in the system 10 on the deposit side is not limited to emitters with their own physical long position in the market. The system 10 may operate a sourcing and buying service through which a potential participant can instruct the system to obtain for them emission reductions in the market. Within such an arrangement, the participant may request that the system 10 act as an agent in the market to source a set tonnage of VERs from third parties. The participant takes ownership of those tonnes and deposits those VERs in the system 10 where they are processed by the conversion engine 16.

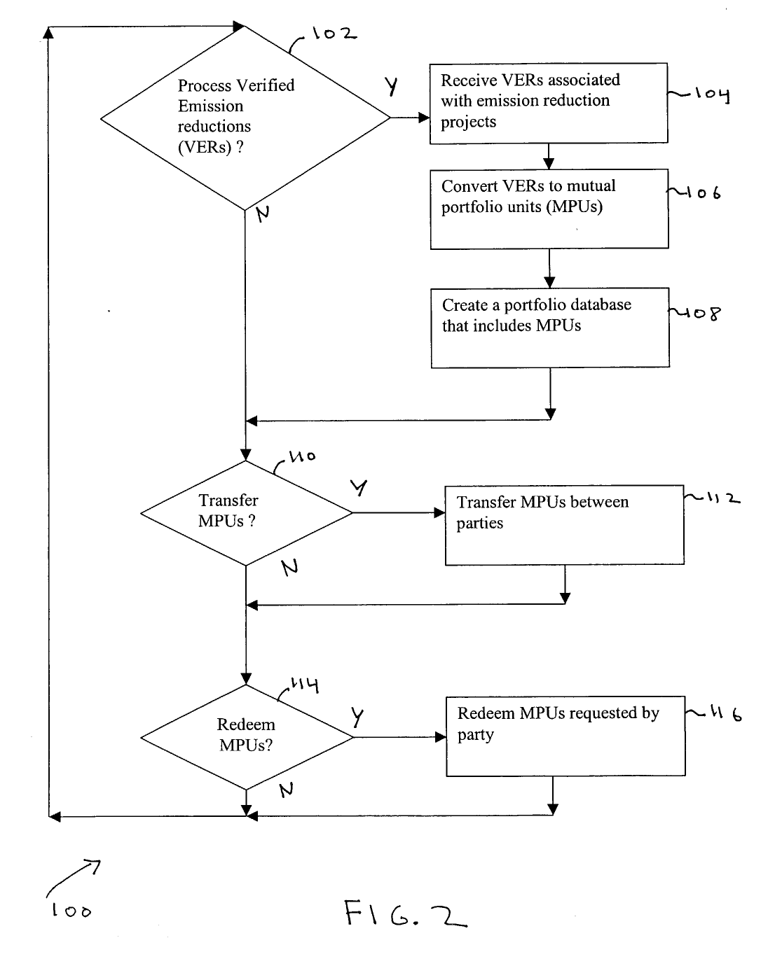

FIG. 2 is a flow chart 100 of a process for handling ERPs 12 in a portfolio system 10 according to an implementation of the invention (see FIG. 1). The process 100 determines (block 102) whether a seller of VERs 14 is seeking to present the VERs to the system for deposit into the system 10. If the seller does present VERs 14, then the process 100 receives (block 104) VERs from the seller. The process 100 may track VERs 14 by creating a record in a database for each VER. The record may include identification information such as an account number related to the seller of the VER, a serial number of each VER tonne deposited, a code for each type of VER deposited, a code for the country where the ERP takes place, a code identifying the verifier, the date of verification, the date/time of deposit, and other information.

The VERs 14 may then be converted (block 106) to one or more MPUs 24. For example, the conversion engine 16 applies assessment criteria which includes factors and risks associated with an ERP 12 such as the type of ERP, factors involved in the ERP, the risks associated with the ERP, and other factors. The conversion engine 16 may employ one or more techniques to implement the assessment criteria. Examples of such techniques can include a risk weighting system in which relative scores are assigned to each of the factors, a decision tree technique in which the nodes of the tree are represented by the factors, or other techniques.

To illustrate, assume that company ‘A’ plans on delivering 50,000 tonnes of VERs per quarter. Further assume that it is a large publicly listed multinational which has bought the rights to a landfill site and holds proven proprietary technology for extracting methane from the site. In contrast, company ‘B’ plans on delivering 100 tonnes of VERs per-year for ten years. In addition, this company is a small operation engaged in a fuel-switching program from the consumption of paraffin to the use of solar energy. In addition, company ‘A’ has a large market capitalization whereas company ‘B’ is private. This information may suggest that company ‘A’ may have a greater financial strength than company ‘B’ and hence may be more likely to deliver the reductions in the long term, whereas company ‘B’ is smaller and less financially robust. Although both companies use proven technologies, company ‘B’ requires the calculation of a baseline. Such a calculation may possess problems in providing accurate verification of the resultant emission reduction. Moreover, company ‘B’ also is in an overseas jurisdiction that may not permit the export of the emission reduction.

Thus, although both companies offer viable projects, the conversion engine may determine that Company ‘A’ might be offered MPUs equating to 42,000 tonnes per quarter (84% conversion ratio) whereas company ‘B’ might only be offered MPUs equating to 50 tonnes per annum for sale into the system 10 (50% conversion ratio.) This example illustrates how the conversion engine may evaluate different sellers such that they obtain different ratios of MPUs relative to their VERs. Every seller may receive a lower tonnage of MPUs than they submit to the system because there is always a risk of non-delivery of future emission reductions.

In addition to the conversion process, the investment review panel 18 may review the MPUs 24 and the conversion process used to produce the MPUs. The panel 18 may convene on a periodic basis such as monthly or quarterly to review the conversion process performed by the conversion engine 16. The investment review panel 18 may assess whether the conversion process appears consistent with their understanding of the risks inherent within each ERP 12. The members of the investment review panel may include the participants of the system 10. This review process may provide some control over the conversion process, may provide opportunities to update the conversion process and act as a forum for promoting dialogue and learning between participants in the portfolio.

Once the conversion engine 16 processes the VERs 14, the process 10 creates (block 108) a portfolio database 20 that include MPUs 24. Each MPU 24 may be associated with a record (e.g. holding account) in the database 20 and may include identification information such a unique account number, the number of shares in the portfolio, expiration dates, and other information.

The process 10 determines (block 110) whether a party is interested in transferring MPUs. If there is a request to transfer MPUs, then the process 100 handles (block 112) the request to transfer ownership of MPUs between parties. Transferring MPUs to purchasers is managed to ensure compliance with regulatory requirements for interacting with a National Registry. For example, UNFCCC has issued a number of reporting requirements for GHG registries. In addition, there is a requirement that national jurisdictions make the name and location of account owners, contact details and the quantity of emissions, by account, publicly accessible at any time.

There is also a requirement to report the transfer of emission reductions. However, there may not be a requirement to track the transfer of future emission reductions. The system 10 may include procedures to differentiate between trades and transfers and to feed all transfers into a reporting system. For example, an emission reduction forward trade may only require the reporting at the date when the transaction matures and the transfer of the emission reduction takes place. No reporting is required prior to the delivery of the contract.

Thus, it is the physical transfer of the emission reduction that is important and not the date when commitments are made to trade the emission reduction. Hence, a transfer is not recorded when a seller deposits VERs in the system 10, rather, the transfer is only recorded when the seller generates VERs (usually at a stated time in the future) and they are transferred to the purchaser.

A national registry may have a requirement to maintain a publicly available record of the emissions reductions. This may include a serial number linking to the following information: project name, project location, both the party and the town/region in which the project is located; year of issue. In addition, information is required on project documentation available electronically on areas such as: project design documents; validation reports; notifications of registration; monitoring reports; verification projects; notification of certification; and notification of issuance of VERs for each project.

The system 10 maintains records for VERs 14 and MPUs 24. There is a requirement to differentiate between VERs that have actually been achieved (i.e. those which have been validated and the VERs actually verified) and the future VERs where the project has been validated but the reduction is anticipated to occur at a specified future point.

This differentiation may allow the system 10 to assess which emission reductions have occurred and which are still forecast to occur in the future. This may help the system 10 manage delivery risk to which reductions are exposed as opposed to the reductions that have been delivered into the portfolio.

The process 100 checks (block 114) the system 10 for a transaction to redeem MPUs 24. If the process 100 detects such a request, the process 100 redeems (block 116) MPUs 24 from the system 10. The redemption process may include matching MPUs 24 presented at the maturity of the contract with the requisite tonnage of verified emission reductions (VERs). Each MPU 24 issued is documented along with its tonnage, time period and other essential characteristics. Each MPU 24 is then matched with the requisite tonnage of emission reductions which are due to be delivered in that time period—the validated and verified emission reductions are then transferred to the purchaser and the MPU expires.

However, when MPU 24 are redeemed, there may be no guarantee regarding which ERP 12 project is used to satisfy a particular MPU. For example, during the course of ERPs 12, it may become apparent that some of the ERPs 12 may be converted to VCUs while other projects within the system 10 may not comply. To manage this potential future conflict, it may be necessary to propose a sharing mechanism whereby MPU holders truly obtain a representative mix of projects within the system 10.

For example, the system 10 may have 1 million tonnes of VERs to spread between the holders of VERs. In one embodiment, the system 10 may divide the VERs 14 between VERs that are convertible to VCUs and VERs that are not convertible. Both subsets may then be further subdivided by category of reduction type—for example fuel switching, forest sequestration. These may then be apportioned between MPU holders in an equitable fashion on the basis, for example, of the size of holding of MPU's receiving that proportion of the convertible reductions.

Once the process 100 processes a request to transfer MPUs (block 112) and/or redeem MPUs (block 116), the process returns to the beginning of the process (block 102) to process any further requests.

The portfolio system 10 may provide one or more of the following advantages. The system 10 may reduce costs for buyers and sellers having emission reduction requirements. The current cost of initiating and completing an emission reduction sale may be significant. In contrast, transacting with the system 10, may involve dealing with a third party which has available expertise, has performed these types of deals in the past, and has an effective and efficient process to guide potential buyers and sellers through the selling process. This may greatly reduce management time, reduce the need to incur significant professional fees and reduce transaction time.

Currently, the amount of management time involved in searching for suitable counter-parties can be extensive. In contrast, transacting with the system 10 may permit both sellers and purchasers to assess with ease whether a market exists to meet their requirements. This offers a way to simplify the complexity of the existing market and to make it more efficient. In addition, the system 10 may allow VERs of requisite quality to be deposited in the system 10 only when they have passed the quality assessment regardless whether or not a buyer for their reductions has been identified.

The system 10 may permit entities wishing to purchase emission reductions with access to high quality MPUs saving considerable time and effort. These cost savings may benefit both the seller and the purchaser and illustrate that the value generated through transacting with the portfolio is cumulative with value accruing to both sellers and purchasers.

The system 10 may provide economies of scales by using professional services. The system 10 may use a limited number of third party verifiers and validators that the system may use for all VERs presented to the system. The system 10 may negotiate competitive deals with these service providers resulting in considerable cost savings in the validation and verification of transactions.

The system 10 may provide anonymity to sellers and purchasers. The system 10 obtains VERs from sellers and removes their identity by accepting specific emission reductions into the system and then issuing MPU from the system. The purchaser of MPUs does not know the identity of the seller of the specific VERs or the nature of the specific projects behind the MPU. This ‘identity scrubbing’ is based on a purchaser of MPUs buying a set tonnage of generic emission reductions with guaranteed delivery potentially backed by an insurance product. The anonymity provided to the sellers may allow them to access a greater market than in the past.

Although confidentiality is required in the operation of the system 10, there is also a requirement for a high degree of transparency in relation to the tonnage within the portfolio. For example, for marketing purposes it may be important to provide information regarding the type of VERs within the portfolio and the identity of the contributors to the portfolio. For example, marketing information may disclose that company A, B and C have each committed at least 100,000 tonnes to the system 10. The tonnage within the system 10 may be based on projects such as fuel switching projects, landfill methane, or other projects. Such information must be packaged to ensure sufficient information is disclosed to convey the high quality of participants and VERs within the system 10 without disclosing information linking directly an original owner to their tonnage of VERs within the system. The system 10 also may ensure that counter-parties in any transfers of VERs are kept confidential, while making public the volume of trades.

Sellers of ERPs may obtain specific benefits by using the system 10. For example, sellers obtain a fungible instrument (i.e. MPU) based on individual emission reduction projects deposited in the system 10. They can either take a share of the portfolio in return in the form of MPUs or their emission reductions can be sold to a third party as part of another MPU.

Traditionally, once a seller had their reduction activity assessed and agreed by the purchaser, the seller would sign over the rights to those reduction units directly to the purchaser. In contrast, participation in the system 10 may offer more dynamic participation in the traded carbon market to those who desire such participation.

Once the system accepts ERPs from a seller, the seller can opt either: to be paid for the reduction added to the system 10 (where they lock in the value for their activities at the market value at that time for the volume of MPU obtained); or to take back the equivalent MPUs equitable to the amount of their VER input and hold those MPUs, to either sell them when the market price rises or to hold them to maturity. This flexibility may allow sellers to release their VERs to the portfolio but defer their payment to a subsequent period when they believe they can maximize their income. This flexibility within the market is not available under the terms of most GHG emission reductions deals performed recently. The system 10 also may provide sellers with the option to retain their reductions until they are certain that they will not need them themselves.

The system 10 may provide sellers with clearly articulated requirements. Currently sellers transact directly with the purchaser, or through a broker. Each purchaser is likely to have differing requirements regarding the quality, eligibility, vintage, validation criteria, verification criteria, and baseline methodology (if applicable). Such differences may make it difficult and costly for sellers of VERs to assess where to sell their VERs. In contrast, transacting with the system 10 may provide an opportunity to deal with a system that provides requirements for the qualification of VERs for inclusion in the portfolio. The system 10 may include requirements which are unlikely to vary significantly allowing sellers to understand what is needed to qualify when planning their emission reduction projects. These requirements may include high standards of technical quality from the ERPS 12 to ensure that the ERPs attracted to the portfolio are high quality.

Likewise, the system 10 may provide specific benefits to purchasers participating in the system. The MPUs may provide the buyer with a source of high quality emission reduction credits. The purchasers may obtain MPUs from the system 10 with the confidence that the VERs underlying the MPUs have been assessed by third party experts. The assessment criteria may ensure that the VERs qualifying for inclusion in the system are of a sufficiently high quality to merit the premium price commanded by a MPU.

The conversion process used to convert VERs into MPUs also may provide purchasers with the knowledge that an assessment has been performed by experts within the system 10 to manage the procurement risk inherent in the purchase of future emission reductions. The use of conversion factor to manage the delivery risk and procurement risk may provide a further empirical measure to assess the viability of the emission reductions being purchased.

An MPU has fungible and transferable characteristics that may provide a significant value for purchasers, regardless of whether they are purchased to hold and retire, to offset against planned future emissions or to sell in the future.

The system 10 may simplify selling MPUs, whether as part of an ongoing emission trading strategy or because future emissions are not anticipated through changes in an operational business plan. MPUs represent standardized contracts for standardized emission reductions and are identical to other MPUs in the market place. As a result, the value of an MPU can quickly be established and a market price derived and the contracts can be transferred to other parties with ease. The ease with which MPUs can be transferred may allow holders to make, for example, a decision not to emit and then allow them to realize the value from their hedge by selling it on the open market.

The delivery of emission reduction tonnes may depend on the performance of the system 10. For example—if an MPU is for the delivery of 100 tonnes of reductions—but the portfolio 20 as a whole delivers 5% more reductions than expected (through a lower than anticipated default rate on VERs) then those excess reductions will be delivered to the purchaser. Similarly, if the portfolio 20 only delivers 95% of the intended reductions then the purchasers will only receive 95% of the reductions they expected.

Buyers may also benefit from portfolio effect of the system 10. The portfolio effect represents the ability to obtain a number of similar asset classes where owning the portfolio of assets changes the risk profile or the asset holding while enabling similar benefits to be enjoyed. In any transaction with a single counter-party, there may exist a risk that the counter-party may not deliver on a number of aspects of their contractual commitment.

Currently, there is a risk in the carbon market that VERs purchased may not be delivered as agreed or that they will not be delivered at all. Traditionally, this represented a significant risk in all transactions. In GHG emission reduction transactions, there have not been many ways of managing this risk. The risk management strategies available have generally not been reasonable—namely sourcing VERs from a large cross section of sellers.

In contrast, the system 10 may provide a means for the management of this risk for purchasers as well as providing risk management opportunities for other risks. In particular, purchasers of a MPU are not purchasing a specific emission reduction unit from a specific organization that will be performing the emission reduction project. Instead, the purchaser is obtaining a unit from the system 10 for a stated volume of future emission reduction. The system 10 includes a variety of emission reductions from a variety of sources that it can use to honor MPUs. So, if one project fails, other available projects exist with which to satisfy the claim upon it from the purchaser. The value of the portfolio effect to the purchaser is that the purchaser is no longer exposed to the failure of a single counter-party to deliver their commitment. In addition, such a benefit may enable risk managers to manage non-systemic risk generated by exposures to specific projects, entities or geographies.

The system 10 manages the portfolio effect within the system by taking into account the portfolio factors into its calculations. For example, it may consider the anticipated failure rate of each of the projects and allowing them to become part of the portfolio.

The system 10 may incorporate a self-insurance product to manage the risk of catastrophic failure of ERPs that may threaten the viability of the portfolio. The system 10 may incorporate an insurance premium taken by the portfolio on every VER transaction in VERs. These VERs may be stored and held in the reserve 18 to provide cover for the risk of default by a seller on its obligations. Thus, the portfolio includes a ‘reservoir’ of credits to enable it to honor its commitments. This reserve may be used subsequently as a premium presented to a third party for an insurance product.

The system 10 may allow purchasers to submit their emission reduction requirements, a tonnage of emission reductions required and, dependant on sufficient tonnes of reductions in the portfolio these can be provided to the purchaser. This may allow purchasers to obtain MPUs when they identify the need for the VERs rather than identifying a need for them and subsequently spending time searching for suitable projects. This may enable a potential purchaser to establish whether the market has the requisite depth of available credits and then provide the information to allow it to effectively price the volume of credits required. As a result, liquidity of the market may be increased.

In addition to providing benefits to participants such as buyers and sellers, the system may provide similar benefits to third parties such as governments, speculators, organizations, existing emission emitters, merchant bankers and other valuation professionals, and other participants.

The system may provide guidance to governments as a model of how the GHG market is evolving. It may show how the existing market players are embracing a commercial need, facing the challenge and generating realistic, commercial workable solutions to the reality of a carbon constrained world. By monitoring the development of the portfolio and its operations, governments and policy setting bodies can learn from the experiences of setting up carbon trading forums in the private sector. It may help governments to enter into negotiations with knowledge of a working scheme that evaluates and trades GHG emission reductions.

Governments and their departments may also benefit from participating in the system 10 as buyers of MPUs or as sellers of VERs. It may also give governments and other public sector stakeholders unprecedented access to the ideas and experiences of leading emitters, brokers, traders, verifiers/certifiers, financiers and other professional service providers interested in the development of emissions trading as a cost-effective means to reduce GHG emissions.

Speculators may also benefit from the system 10. The commoditization of the market and the reduction of barriers to entry (i.e. non emitters can obtain positions in MPUs and then trade them without having to get involved in the underlying emission reduction projects) may allow speculators to enter the market. As a result, this may provide: greater liquidity within the markets as more buyers and sellers enter the markets; more efficient and accurate pricing of the MPUs; an increase in financial market methodologies to the pricing and structuring of deals which will further enhance liquidity; an acceleration of the acceptance of GHG trading as a legitimate form of trading; and the increase in the credibility of GHG products as legitimate tools for risk managers and members of a non-government organization (NGO) community.

Organizations may exist on both sides of the market that may benefit from the system. When they are able to recognize a structured market place, they may be in inclined to invest in ERPs/MPUs that have an effective methodology behind them and which are seen to embody confidence in the other major market players.

The development of a market price for VERs may enable existing emitters to perform meaningful analysis on the likely future costs of compliance/non-compliance with any future reductions required. This may lead to relevant emit or not emit decisions to be made. This type of analysis is likely to be performed by significant emitters such as power stations or chemical plants, but could easily be performed by small operations. This may provide them with a risk management solution for their carbon risk management program.

Merchant bankers and other valuation professionals may also benefit from the system 10. In the past, whenever future valuations were performed, there had been a tendency to discount the effects of a carbon constrained economy either because it was deemed immaterial or too difficult to obtain accurate reliable data. In contrast, the system 10 may provide price transparency and improve factoring financial implications of a carbon constrained economy into valuation models enabling a meaningful assessment of future liabilities (or income) into pricing decisions.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
receiving verified emission reductions(VERs) associated with emission reduction projects (ERPs);
converting the VERs into mutual portfolio units (MPUs) based on predetermined factors;
creating an emissions reduction portfolio of MPUs; and
creating a database based on the portfolio.

2. The method of claim 1, wherein the ERPs include at least one of: a renewable energy project; an emission reduction from process improvements in manufacturing; an energy efficiency improvement project; a fuel switching project; a carbon sequestration program; a transportation efficiency improvement project; a solar power technology project; a fuel-switching program; a reforestation project; or a project to reduce methane, perfluorocarbons (PFCs), hydrochlorofluorocarbons (HFCs), nitrous oxide (N2O) or sulphur hexafluoride (SF6) emissions.

3. The method of claim 1, wherein the predetermined factors include at least one of: a country in which an ERP is based; a country in which the seller of an ERP is based; the credit rating of a company associated with an ERP; the technology related to an ERP; catastrophic risk associated with an ERP; emission data associated with an ERP; or a government having jurisdiction over an ERP.

4. The method of claim 1, wherein the predetermined factors include at least one of: procurement risk; market risk; credit risk; fraud risk; or legal risk.

5. The method of claim 1, wherein the MPUs have a risk profile of substantially the entire portfolio and are not tied to any specific ERP.

6. The method of claim 1, further comprising processing a request to transfer ownership of MPUs between parties.

7. The method of claim 1, further comprising processing a request to redeem MPUs from the portfolio.

8. The method of claim 1, further comprising processing a request to display over a network information associated with at least one of VERs, ERPS, and MPUs.

9. The method of claim 1, further comprising providing an investment review panel to review the predetermined factors and modifying the predetermined factors if any of a list of predetermined criteria change.

10. The method of claim 1, further comprising converting the MPUs into valid compliance units (VCUs).

11. The method of claim 10, further comprising providing an insurance product to guarantee the conversion of MPUs into valid compliance units (VCUs).

12. The method of claim 1, further comprising charging membership fees for evaluating potential VERs for the portfolio.

13. The method of claim 1, further comprising charging a percentage of the value of the VERs as a fee for converting VERs to MPUs.

14. The method of claim 1, further comprising charging brokering fees for transferring MPUs between parties.

15. The method of claim 1, further comprising charging administrative fees for redeeming MPUs.

16. A system comprising:
an emissions reduction portfolio database of mutual portfolio units (MPUs); and
a processor coupled to the database, the processor having a memory executing a program for converting verified emission reductions(VERs) into MPUs.

17. The system of claim 16, wherein the ERPs include at least one of: a renewable energy project; an emission reduction from process improvements in manufacturing; an energy efficiency improvement project; a fuel switching project; a carbon sequestration program; a transportation efficiency improvement project; a solar power technology project; a fuel-switching program; a reforestation project; or a project to reduce methane, perfluorocarbons (PFCs), hydrochlorofluorocarbons (HFCs), nitrous oxide (N2O) or sulphur hexafluoride (SF6) emissions.

18. The system of claim 16, wherein the predetermined factors include at least one of: a country in which an ERP is based; a country in which the seller of an ERP is based; the credit rating of a company associated with an ERP; the technology related to an ERP; catastrophic risk associated with an ERP; emission data associated with an ERP; or a government having jurisdiction over an ERP.

19. The system of claim 16, wherein the predetermined factors include at least one of: procurement risk; market risk; credit risk; fraud risk; or legal risk.

20. The system of claim 16, wherein the MPUs have a risk profile of substantially the entire portfolio and not tied to any specific ERP.

21. The system of claim 16, the processor further configured to process a request to transfer ownership of MPUs between parties.

22. The system of claim 16, the processor further configured to process a request to redeem MPUs from the portfolio.

23. The system of claim 16, the processor further configured to process a request to display over a network information associated with at least one of: VERs; ERPS; or MPUs.

24. The system of claim 16, the processor further configured to provide an investment review panel to review the predetermined factors and modifying the predetermined factors if any of a list of predetermined criteria change.

25. The system of claim 16, the processor further configured to convert the MPUs into valid compliance units (VCUs).

26. The system of claim 25, the processor further configured to provide an insurance product to guarantee the conversion of MPUs into valid compliance units (VCUs).

27. The system of claim 16, the processor further configured to charge membership fees for evaluating potential VERs for the portfolio.

28. The system of claim 16, the processor further configured to charge a percentage of the value of the VERs as a fee for converting VERs to MPUs.

29. The system of claim 16, the processor further configured to charge brokering fees for transferring MPUs between parties.

30. The system of claim 16, the processor further configured to charge administrative fees for redeeming MPUs.

31. An article comprising a computer-readable medium that stores computer-executable instructions for causing a computer system to:
receive verified emission reductions (VERs) associated with emission reduction projects (ERPs);
convert VERs into mutual portfolio units (MPUs) based on predetermined factors;
create an emissions reduction portfolio database of MPUs.

32. The article of claim 31 including instructions to process a request to transfer ownership of MPUs between parties.

33. The article of claim 31 including instructions to process a request to redeem MPUs from the portfolio.

34. The article of claim 31 including instructions to process a request to display over a network information associated with at least one of VERs, ERPs, and MPUs.

35. The article of claim 31 including instructions to provide an investment review panel to review the predetermined factors and modifying the predetermined factors if any of a list of predetermined criteria change.

36. The article of claim 31 including instructions to convert the MPUs into valid compliance units (VCUs).

37. The article of claim 31 including instructions to provide an insurance product to guarantee the conversion of MPUs into valid compliance units (VCUs).

38. The article of claim 31 including instructions to charge membership fees for evaluating potential VERs for the portfolio.

39. The article of claim 31 including instructions to charge a percentage of the value of the VERs as a fee for converting VERs to MPUs.

40. The article of claim 31 including instructions to charge brokering fees for transferring MPUs between parties.

41. The article of claim 31 including instructions to charge administrative fees for redeeming MPUs.

42. A method comprising:
receiving verified emission reductions (VERs) associated with emission reduction projects (ERPs);
converting VERs into mutual portfolio units (MPUs) based on predetermined factors;
creating an emissions reduction portfolio database of MPUs; and
processing at least one of a request to transfer ownership of at least one MPU between parties, and a request to redeem at least one MPU from the portfolio.

43. The method of claim 42, wherein the ERPs include at least one of: a renewable energy project; an emission reduction from process improvements in manufacturing; an energy efficiency improvement project; a fuel switching project; a carbon sequestration program; a transportation efficiency improvement project; a solar power technology project; a fuel-switching program; a reforestation project; or a project to reduce methane, perfluorocarbons (PFCs), hydrochlorofluorocarbons (HFCs), nitrous oxide (N2O) or sulphur hexafluoride (SF6) emissions.

44. The method of claim 42, wherein the predetermined factors include at least one of: a country in which an ERP is based; a country in which the seller of an ERP is based; the credit rating of a company associated with an ERP; the technology related to an ERP; catastrophic risk associated with an ERP; emission data associated with an ERP; or a government having jurisdiction over an ERP.

45. The method of claim 42, wherein the predetermined factors include at least one of: procurement risk; market risk; credit risk; fraud risk; or legal risk.

46. The method of claim 42, wherein the MPUs have a risk profile of substantially the entire portfolio and are not tied to any specific ERP.

47. The method of claim 42, further comprising processing a request to display over a network information associated with at least one of: VERs; ERPs; or MPUs.

48. The method of claim 42, further comprising providing an investment review panel to review the predetermined factors and modifying the predetermined factors if any of a list of predetermined criteria change.

49. The method of claim 42, further comprising converting the MPUs into valid compliance units (VCUs).

50. The method of claim 42, further comprising providing an insurance product to guarantee the conversion of MPUs into valid compliance units (VCUs).

51. The method of claim 42, further comprising charging membership fees for evaluating potential VERs for the portfolio.

52. The method of claim 42, further comprising charging a percentage of the value of the VERs as a fee for converting VERs to MPUs.

53. The method of claim 42, further comprising charging brokering fees for transferring MPUs between parties.

54. The method of claim 42, further comprising charging administrative fees for redeeming MPUs.

55. A method comprising:
providing consulting services to potential sellers of emissions reduction units (VERs);
providing an account for holding VERs that have been validated and verified; and
charging fees to process VERs.

56. The method of claim 55, wherein the account is in a portfolio database.

57. The method of claim 55, wherein the ERPs include at least one of: a renewable energy project; an emission reduction from process improvements in manufacturing; an energy efficiency improvement project; a fuel switching project; a carbon sequestration program; a transportation efficiency improvement project; a solar power technology project; a fuel-switching program; a reforestation project; or a project to reduce methane, perfluorocarbons (PFCs), hydrochlorofluorocarbons (HFCs), nitrous oxide (N2O) or sulphur hexafluoride (SF6) emissions.

59. The method of claim 58, wherein the predetermined factors include at least one of: a country in which an ERP is based; a country in which the seller of an ERP is based; the credit rating of a company associated with an ERP; the technology related to an ERP; catastrophic risk associated with an ERP; emission data associated with an ERP; or a government having jurisdiction over an ERP.

60. The method of claim 58, wherein the predetermined factors are associated with emissions reduction projects (ERPs) and include at least one of: procurement risk; market risk; credit risk; fraud risk; or legal risk.

61. The method of claim 55, wherein processing includes processing a request to transfer ownership of mutual portfolio units (MPUs) between parties, wherein MPUs are based on VERs.

62. The method of claim 55, wherein processing includes processing a request to redeem mutual portfolio units (MPUs) from the portfolio, wherein MPUs are based on VERs.

63. The method of claim 55, wherein processing includes processing a request to convert VERs to mutual portfolio units (MPUs).

64. The method of claim 55, wherein processing includes processing a request to display over a network information associated with at least one of VERs and mutual portfolio units (MPUs), wherein MPUs are based on VERs.

65. The method of claim 55, further comprising providing an investment review panel to review predetermined factors and modifying the predetermined factors if any of a list of predetermined criteria change.

66. The method of claim 55, further comprising converting mutual portfolio units (MPUs) into valid compliance units (VCUs), wherein MPUs are based on VERs.

67. The method of claim 55, further comprising providing an insurance product to guarantee the conversion of mutual portfolio units (MPUs) into valid compliance units (VCUs), wherein MPUs are based on VERs.

68. The method of claim 55, further comprising charging membership fees for evaluating potential VERs for the portfolio, wherein MPUs are based on VERs.

69. The method of claim 55, further comprising charging a percentage of the value of the VERs as a fee for converting VERs to mutual portfolio units (MPUs), wherein MPUs are based on VERs.

70. The method of claim 55, further comprising charging brokering fees for transferring mutual portfolio units (MPUs) between parties, wherein MPUs are based on VERs.

71 The method of claim 55, further comprising charging administrative fees for redeeming mutual portfolio units (MPUs), wherein MPUs are based on VERs.

72. A method comprising:
accepting verified emission reductions (VERs);
providing consulting services to sellers of VERs to verify the VERs;
converting accepted VERs into mutual portfolio units (MPUs); and
issuing shares to sellers in exchange for the VERs.

73. The method of claim 72, wherein each share is an asset backed tradable security based on a percentage of the value of the entire portfolio.

74. The method of claim 72, wherein VERs represent emissions reductions that have been verified by a third party indicating that a stated reduction has occurred in a stated period.
